(19) United States
(12) Patent Application Publication
(10) Pub. No.: US 2011/0317017 A1
(43) Pub. Date: Dec. 29, 2011

(54) PREDICTIVE DUTY CYCLE ADAPTATION SCHEME FOR EVENT-DRIVEN WIRELESS SENSOR NETWORKS

(75) Inventors: Joonhwa Shin, West Lafayette, IN (US); Johnny Park, Lafayette, IN (US); Avinash Kak, West Lafayette, IN (US); Hidekazu Iwaki, Tokyo (JP); Akio Kosaka, Tokyo (JP)

(73) Assignees: OLYMPUS CORPORATION, Tokyo (JP); PURDUE RESEARCH FOUNDATION, West Lafayette, IN (US)

(21) Appl. No.: 13/254,555

(22) PCT Filed: Aug. 20, 2010
(86) PCT No.: PCT/US10/46059

§ 371 Date: Sep. 2, 2011

Related U.S. Application Data
(60) Provisional application No. 61/235,415, filed on Aug. 20, 2009.

(51) Int. Cl. H04N 7/18

(52) U.S. Cl. 348/159; 348/E07.085

(57) ABSTRACT

Embodiments of a method for controlling access to a shared communications medium by a plurality of nodes are disclosed. The method may comprise predicting, for each node of the plurality of nodes, whether an event will occur within a sensing field of that node at a future time and adapting a communications schedule of each node in response to the prediction regarding that node. Wireless sensor networks and computer readable media implementing embodiments of a method for controlling access to a shared communications medium by a plurality of nodes are also disclosed.

### CROSS REFERENCE TO RELATED APPLICATIONS

This application claims priority under 35 U.S.C. §119(e) to U.S. Provisional Application Ser. No. 61/235,415, filed on Aug. 20, 2009, the entire disclosure of which is expressly incorporated herein by reference.

### TECHNICAL FIELD

The present disclosure generally relates to medium access control protocols for event-driven wireless sensor networks. More particularly, the present disclosure relates to a medium access control protocol that employs a predictive duty cycle adaptation scheme.

### BACKGROUND ART

A wireless sensor network (WSN) is a group of sensor nodes—each typically equipped with sensing, information processing, and wireless communication capabilities—that are deployed in an area to cooperatively monitor physical or environmental conditions. The nodes in a WSN for passive environmental monitoring, for example, are devoted to making sensing measurements (e.g., temperature, pressure, light intensity, et cetera) which may be collected and reported to a remote host by relaying through multi-hop communications. A newer class of WSNs, referred to as “event-driven” WSNs, are typically deployed to detect and track events of interest, such as humans or other objects in a target tracking application, for example. A characteristic feature of event-driven WSNs is the spatially-correlated bursty traffic that occurs in the vicinity of the events, which may have large mobilities. In such networks, the events spawned by moving targets trigger, on a continuous basis, the initiation of new communication links between new pairs of nodes and new routing paths. One illustrative example of an event-driven WSN, which well characterizes the class, is a wireless camera network (WCN).

Access to a shared wireless communications medium by the nodes of a WSN is generally arbitrated by a medium access control (MAC) protocol. Designers of WSNs and MAC protocols typically attempt to maximize both the lifetime of the nodes and the network performance (e.g., the minimization of latency and the maximization of throughput in the network). Among various MAC techniques, duty cycling the communications radio of each node is generally considered one of the most effective ways to conserve energy and, thereby, increase the lifetime of each node. By alternating sleep and active modes and by transmitting data only during the active mode, a node can avoid unnecessary energy consumption. Changing the node's duty cycles, however, directly affects communication latency at the nodes. As a result, trying to minimize both latency and energy expenditure involves a fundamental tradeoff.

Various approaches have been proposed to balance this tradeoff. In addition to static duty cycling schemes, several proposed approaches employ adaptive or dynamic duty cycling schemes in which the duty cycle adaptation of a node is based upon the detection of an event of interest (usually defined in terms of the current traffic conditions of the node). Some MAC protocols, designed specifically for event-driven WSNs, attempt to minimize the latency of either a subset of or all of the event-triggered messages by removing redundancy among packets or by exploiting multiple channels, but these efforts are still only made after an event of interest actually occurs. These existing duty cycle adaptation schemes are passive and, thus, work best when the same communication links or routing paths are reused repeatedly, even in the vicinity of an event (i.e., under the conditions for which the communication parameters had been previously adjusted for the entire paths or links)—a condition typically satisfied by WSNs intended for passive environmental monitoring. These approaches based on reactive adaptation, however, perform poorly under the conditions prevalent in event-driven WSNs due to the inherent delay between the detection of a new event and the reaction of the MAC protocol to the event, especially when the mobility of the event is large, resulting in sub-optimal performance for the event-driven WSN with respect to both latency and energy conservation.

The aforementioned MAC protocols and related techniques are described in: G. Welch et al., An Introduction to the Kalman Filter (1995); A. Aljadhai et al., “Predictive Mobility Support for QoS Provisioning in Mobile Wireless Environments,” 19 IEEE J. on Selected Areas Comms. 1915-1930 (2001); M. Buettner et al., “X-Mac: A Short Preamble Mac Protocol for Duty cycled Wireless Sensor Networks,” Proc. 4th Int'l Conf. on Embedded Networked Sensor Sys. 307-320 (2006); A. El-Hoiyadi et al., “WiseMAC: An Ultra Low Power MAC Protocol for Multi-Hop Wireless Sensor Networks,” 3121 Lecture Notes in Computer Sci. 18-31 (2004); P. Lin et al., “Medium Access Control with a Dynamic Duty Cycle for Sensor Networks,” 3 IEEE Wireless Comms. & Networking Conf. (2004); K. Jamieson et al., “Sift: A MAC Protocol for Event-Driven Wireless Sensor Networks,” 3868 Lecture Notes in Computer Sci. 260 (2006); B. Kusy et al., “Elapsed Time on Arrival: A Simple and Versatile Primitive for Canonical Time Synchronization Services,” 1 Int'l J. Ad Hoc Ubiquitous Computing 239-51 (2006); S. Liu et al., “CMAC: An Energy Efficient MAC Layer Protocol Using Convergent Packet Forwarding for Wireless Sensor Networks,” 7 Proc. IEEE Se. Conf. (2007); T. Liu et al., “Mobility Modeling, Location Tracking, and Trajectory Prediction in Wireless ATM Networks,” 16 IEEE J. on Selected Areas Comms. 922-936 (1998); Y. Nam et al., “An Adaptive MAC (A-MAC) Protocol Guaranteeing Network Lifetime for Wireless Sensor Networks,” Proc. 12th Eur. Wireless Conf. (2006); V. Namboodiri et al., “Alert: An Adaptive Low-Latency Event-Driven MAC Protocol for Wireless Sensor Networks,” Proc. 7th Int'l Conf. on Info. Processing in Sensor Networks 159-170 (2008); J. Polastre et al., “Versatile Low Power Media Access for Wireless Sensor Networks,” Proc. 2d Int'l Conf. on Embedded Networked Sensor Sys. 95-107 (2004); I. Rhee et al., “Z-MAC: A Hybrid MAC for Wireless Sensor Networks,” 16 IEEE/ACM Transactions on Networking, 511-524 (2008); T. Van Dam et al., “An Adaptive Energy-Efficient MAC Protocol for Wireless Sensor Networks,” Proc. 1st Int'l Conf. on Embedded Networked Sensor Sys. 171-180 (2003); and W. Ye et al., “An Energy-Efficient MAC Protocol for Wireless Sensor Networks,” 3 Proc. 21st Ann. Joint Conf. IEEE Computer & Comms. Societies (2002). The entire disclosures of each of the above listed references is expressly incorporated herein by reference. This listing is not intended as a representation that a complete search of all relevant prior art has been conducted or that no better reference than those listed above exist; nor should any such representation be inferred.

### DISCLOSURE OF THE INVENTION

The present invention comprises one or more of the features recited in the appended claims and/or the following features which, alone or in any combination, may comprise patentable subject matter.

According to one aspect, a method for controlling access to a shared communications medium by a plurality of nodes comprises predicting, for each node of the plurality of nodes, whether an event will occur within a sensing field of that node at a future time and adapting a communications schedule of each node in response to the prediction regarding that node.

In some embodiments, predicting whether an event will occur within a sensing field of each node at a future time may include predicting whether a camera of each node will observe an object of interest at the future time. In other embodiments, predicting whether an event will occur within a sensing field of each node at a future time may include estimating a spatio-temporal event probability (STEP) at each node of the plurality of nodes. Estimating the STEP at each node of the plurality of nodes may include integrating a position uncertainty of an event over the sensing field of each node at the future time.

In other embodiments, estimating the STEP at each node of the plurality of nodes comprises using a recursive parameter estimator. Using a recursive parameter estimator may include using one of a Kalman filter and a particle filter. The method may further include receiving or overhearing, with a first node of the plurality of nodes, a packet from a second node of the plurality of nodes, the packet including a measurement of an event. The method may further include estimating a new STEP at the first node by updating the recursive parameter estimator using the measurement of the event. The method may further include initializing a new instance of the recursive parameter estimator when the measurement is not within a predicted uncertainty region for the event. The method may further include terminating an instance of the recursive parameter estimator after a predefined period of time during which no packets including a new measurement of the event are received or overheard by the first node. The communications schedule of the first node may be adapted to a lowest duty cycle in response to the termination of the instance of the recursive parameter estimator.

In still other embodiments, adapting the communications schedule of each node may include adjusting a duty cycle of a radio of each node. Adjusting the duty cycle of the radio of each node may include determining to which probability subspace of a predicted uncertainty region of an event each node belongs. Adjusting the duty cycle of the radio of each node may include exponentially varying a frame length utilized by each radio. In some embodiments, the method may further include transmitting a packet containing a dedicated field, the dedicated field including a first bit indicating whether a node transmitting the packet is currently sensing an event. The dedicated field may also include a second bit indicating whether the node transmitting the packet is currently transferring event-related data.

According to another aspect, one or more tangible, non-transitory computer readable media comprises a plurality of instructions which, when executed by a processor of a first node, cause the processor to predict whether an event will occur within a sensing field of the first node at a future time and adapt a communications schedule of the first node in response to the prediction, the communications schedule controlling access by the first node to a communications medium shared between a plurality of nodes.

In some embodiments, predicting whether an event will occur within a sensing field of the first node at a future time may include predicting whether a camera of the first node will observe an object of interest at the future time. In other embodiments, predicting whether an event will occur within a sensing field of the first node at a future time may include estimating a spatio-temporal event probability (STEP) at the first node. Estimating the STEP at the first node may include integrating a position uncertainty of an event over the sensing field of the first node.

In other embodiments, estimating the STEP at the first node may include using a recursive parameter estimator. Using a recursive parameter estimator may include using one of a Kalman filter and a particle filter. The plurality of instructions may further cause the processor to receive or overhear a packet from a second node of the plurality of nodes, the packet including a measurement of an event. The plurality of instructions may further cause the processor to estimate a new STEP at the first node by updating the recursive parameter estimator using the measurement of the event. The plurality of instructions may further cause the processor to initialize a new instance of the recursive parameter estimator when the measurement is not within a predicted uncertainty region for the event. The plurality of instructions may further cause the processor to terminate an instance of the recursive parameter estimator after a predefined period of time during which no packets including a new measurement of the event are received or overheard by the first node. The communications schedule of the first node may be adapted to a lowest duty cycle in response to the termination of the instance of the recursive parameter estimator.

In still other embodiments, adapting the communications schedule of the first node may include adjusting a duty cycle of a radio of the first node. Adjusting the duty cycle of the radio of the first node may include determining to which probability subspace of a predicted uncertainty region of an event the first node belongs. Adjusting the duty cycle of the radio of the first node may include exponentially varying a frame length utilized by the radio of the first node. The plurality of instructions may further cause the processor to transmit a packet containing a dedicated field, the dedicated field including a first bit indicating whether the first node is currently sensing an event. The dedicated field may further include a second bit indicating whether the first node is currently transferring event-related data.

According to yet another aspect, a wireless sensor network comprises a plurality of nodes, each node including a control circuit and a radio providing access to a communications medium shared between the plurality of nodes, the control circuit of each node being configured to (i) predict whether an event will occur within a sensing field of that node at a future time and (ii) adjust a duty cycle of the radio of that node in response to the prediction.

In some embodiments, each node may include a camera, and the control circuit of each node may be configured to predict whether the camera of that node will observe an object of interest at the future time. In other embodiments, the control circuit of each node may be configured to predict whether an event will occur within a sensing field of that node at a future time by estimating a spatio-temporal event probability (STEP) at that node. The control circuit of each node may be configured to estimate a spatio-temporal event probability (STEP) at that node by integrating a position uncertainty of an event over the sensing field of that node.

In other embodiments, the control circuit of each node may be configured to estimate a spatio-temporal event probability (STEP) at that node using a recursive parameter estimator. The recursive parameter estimator may be one of a Kalman filter and a particle filter. The control circuit of each node may be further configured to receive or overhear a packet from another node of the plurality of nodes via the radio, the packet including a measurement of an event. The control circuit of each node may be further configured to estimate a new STEP at that node by updating the recursive parameter estimator using the measurement of the event. The control circuit of each node may be further configured to initialize a new instance of the recursive parameter estimator when the measurement is not within a predicted uncertainty region for the event. The control circuit of each node may be further configured to terminate an instance of the recursive parameter estimator after a predefined period of time during which no packets including a new measurement of the event are received or overheard by that node. The control circuit of each node may be further configured to adjust the duty cycle of the radio of that node to a lowest duty cycle in response to the termination of the instance of the recursive parameter estimator.

In still other embodiments, the control circuit of each node may be configured to adjust a duty cycle of the radio of that node by determining to which probability subspace of a predicted uncertainty region of an event the that node belongs. The control circuit of each node may be configured to adjust a duty cycle of the radio of that node by exponentially varying a frame length utilized by the radio of that node. The control circuit of each node may be further configured to transmit a packet containing a dedicated field via the radio, the dedicated field including a first bit indicating whether that node is currently sensing an event. The dedicated field may further include a second bit indicating whether that node is currently transferring event-related data.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF DRAWINGS

The detailed description particularly refers to the accompanying figures, in which:

FIG. 1 illustrates a state transition diagram for typical cluster-based, distributed processing of vision data in an exemplary WCN;

FIG. 2 illustrates one embodiment of wireless camera-based sensor nodes that may be used in an exemplary WCN;

FIG. 3A illustrates the partially overlapping communications ranges of nodes in an exemplary WCN;

FIG. 3B illustrates the partially overlapping sensing fields of the nodes of the exemplary WCN of FIG. 3A;

FIG. 3C illustrates the exemplary WCN of FIGS. 3A-B engaged in tracking a moving object of interest and delivering aggregated data to a base station;

FIG. 4 illustrates the interaction between a MAC layer and an application layer 28 of an exemplary WCN node;

FIG. 5 illustrates state transition diagrams for the MAC layer and the application layer of the exemplary WCN node of FIG. 4;

FIG. 6 illustrates the viewing frustum of a pinhole camera model as the three-dimensional space enclosed by the near plane and the far plane;

FIG. 7A illustrates an exemplary duty cycle distribution in the WCN of FIG. 3 at an initial time instant;

FIG. 7B illustrates relationship between the an exemplary duty cycle distribution of FIG. 7A and the centers of the sensing fields of the nodes in the WCN of FIG. 3;

FIG. 7C illustrates an exemplary duty cycle distribution in the WCN of FIG. 3 at a subsequent time instant;

FIG. 8 illustrates the exponentially varying frame lengths of an exemplary WCN employing four different duty cycle levels;

FIG. 9 illustrates an exemplary timeline for adopting a new schedule with a higher duty cycle;

FIG. 10A illustrates the results of a simulation comparing the average per-hop latency at different sampling intervals for WCNs employing an illustrative MAC protocol according to the present disclosure, the AMAC protocol, and four TMAC protocols with different duty cycles;

FIG. 10B illustrates the results of a simulation comparing the normalized throughput at different sampling intervals for WCNs employing the MAC protocols of FIG. 10A;

FIG. 10C illustrates the results of a simulation comparing the average energy consumption at different sampling intervals for WCNs employing the MAC protocols of FIG. 10A;

FIG. 11A illustrates the results of a simulation comparing the time-bounded parameter estimation accuracy (TIBPEA) at different timeout periods, with an average target speed of three meters per second, for WCNs employing the MAC protocols of FIG. 10A; and

FIG. 11B illustrates the results of a simulation comparing the TIBPEA at different timeout periods, with an average target speed of six meters per second, for WCNs employing the MAC protocols of FIG. 10A.

### BEST MODES FOR CARRYING OUT THE INVENTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but, on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices may be set forth in order to provide a more thorough understanding of the present disclosure. It will be appreciated, however, by one skilled in the art that embodiments of the disclosure may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

Embodiments of the disclosed systems and methods may be implemented in hardware, firmware, software, or any combination thereof. By way of example, embodiments of the disclosed systems and methods may be implemented as instructions stored on one or more tangible, machine-readable media, which may be read and executed by one or more processors. A tangible, machine-readable medium may include any mechanism for storing or transmitting information in a form readable by a machine (e.g., a processor). A tangible, machine-readable medium may illustratively include read only memory (ROM), random access memory (RAM), magnetic disk storage, optical storage, flash memory, and/or other types of memory devices.

The present disclosure describes a predictive duty cycle adaptation (PDCA) scheme specifically designed for event-driven WSNs. Whereas existing approaches passively (i.e., reactively) adapt the duty cycles of nodes according to currently experienced network conditions, the presently disclosed PDCA scheme actively adapts the duty cycle schedule at each node by predicting the likelihood that an event of interest will occur within the node's sensing field in the near future. This likelihood is referred to herein as the “spatio-temporal event probability” (STEP) at a node. A WSN employing this PDCA scheme allows nodes expecting bursty traffic to alter their communication protocol parameters prior to the actual increase in communication traffic (thereby reducing overall latency across the network).

The presently disclosed PDCA scheme gives each node an ability to detect ongoing events through its neighboring nodes, extending the effective sensing field of each node to also include the sensing fields of its communication neighbors. In some embodiments, this may be achieved with the help of a 1-bit or 2-bit field in the headers of packets received from neighboring nodes, as explained in more detail below. Under this PDCA scheme, when a node is experiencing an event, its neighboring nodes are aware of the event (even when not directly experiencing the same). Thus, if a node experiencing an event is able to predict which of its neighboring nodes will experience the same event next, those neighbors can alter their protocol parameters before the event actually arrives. In one illustrative embodiment, this prediction is implemented using a Kalman filter-based tracking algorithm embedded in the MAC layer, allowing each node to probabilistically localize a currently occurring event with an additional communication overhead of only one or two bits. The recursive estimation and prediction of events of interest may be carried out at each node in a completely distributed way in this PDCA scheme. Furthermore, the proposed PDCA scheme allows different nodes in the network to operate under distinct duty cycles, resulting in heterogeneous node schedules. To avoid any issues arising from non-overlapping active periods between neighboring nodes, a mechanism may be included in the PDCA scheme that allows each node to calculate the moments when it is allowed to transmit messages to its neighboring nodes based solely on the knowledge of their respective schedules (i.e., without resorting to additional message exchanges). Before describing this predictive approach to the reconfiguration of MAC protocol parameters in detail, the present disclosure first surveys several of the unique features of event-driven WSNs. A simulated performance evaluation of one illustrative embodiment of a WCN utilizing the PDCA scheme is also presented below, in the context of target tracking (with a performance comparison to known TMAC and AMAC protocols).

Event-driven WSNs differ from more traditional WSNs, in that events occurring in the network environment are likely to cause radio broadcast traffic to become bursty amongst the nodes in the vicinity of the events. To process (in some cases, collaboratively) the sensed data in real-time and to avoid losing any event-related information, the nodes of an event-driven WSN should be able to quickly alter their communication protocol parameters (e.g., within a duty cycle). Due to the limited computational power and sensing capability of each individual node, the sensor nodes in an event-driven WSN often collaborate with one another in order to detect events of interest and to estimate their various attributes. This characteristic may be contrasted with the nodes of more traditional WSNs, where scalar measurements are acquired by each node independently and simply aggregated in the network in order to remove redundancies in data transmission. One example of a more traditional WSN is a wireless network designed for monitoring an environment for air quality. A wireless camera network (WCN), on the other hand, is an illustrative example of an event-driven WSN. In an illustrative WCN, the nodes may be called upon not only to detect the presence of humans or other objects in the environment but also to follow the movement of the detected humans or objects.

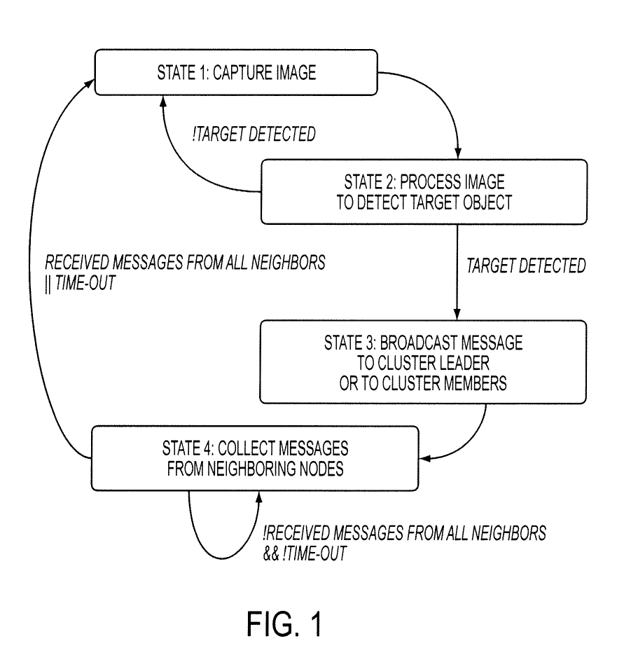

In the illustrative WCN (or other event-driven WSNs), tasks such as object detection and tracking may involve computations beyond the capabilities of the processor at any single node. Such computations may require a cluster-based, distributed implementation of the appropriate algorithms, as described in currently pending U.S. Patent Application Publication No. 2010/0073686, entitled “Clustering Protocol for Directional Sensor Networks,” the entire disclosure of which is expressly incorporated herein by reference. As described therein, the clusters used for such collaborative processing typically consist of nodes that can each capture some sensory information related to the event. Collaborative computations often involve intensive message exchanges within a cluster, resulting in highly bursty communications that (unless the communication protocol parameters are changed in a timely manner) may be characterized by frequent packet collisions, resulting in a waste of energy and a failure to transmit critical data. The state transition diagram illustrated in FIG. 1 presents a summary of the various computational steps that may be executed when collaboratively tracking an object, in one illustrative embodiment of a WCN.

Event-driven WSNs also possess demanding quality of service (QoS) requirements. The purpose of an event-driven WSN is primarily to detect an event of interest and to perform event-specific tasks in a timely manner. Returning to the illustrative WCN, deployed in a large area for surveillance purposes, the transmission of event information to the end user in a timely manner may require a certain QoS with regard to communications throughout the network. A WSN may also require appropriate QoS metrics from the standpoint of cluster communications for collaborative problem solving by the nodes. Achieving a high QoS by simply over-provisioning nodes so they are able to cater to expected peak traffic is generally not feasible for WSNs due to the resource-constrained nature of the individual nodes. Likewise, simply reducing the duty cycle of the nodes is also generally not a feasible solution in WSNs, as this would adversely affect the QoS. As described in more detail below, various QoS metrics can be used to compare prior art passive duty-cycle adaptation schemes with the illustrative embodiment of a WCN utilizing the PDCA scheme set forth herein.

The presently disclosed PDCA scheme addresses the unique features of event-driven WSNs by actively adjusting the duty cycle of the nodes that are about to experience an event of interest that may provoke high communication traffic. As used herein, the “duty cycle” of a node refers to the ratio of the duration that the radio of the node is awake during a period (as compared to the entire duration of the period). As will be apparent to those of skill in the art, increasing the duty cycle too far in advance of the actual occurrence of an event at a node may result in wasted energy, while waiting to increase the duty cycle until after the event has arrived may prevent the transmission of critical packets in a timely manner, possibly increasing latency.

The presently disclosed PDCA scheme balances these two important, but non-complementary, objectives (i.e., high energy efficiency and low communication latency) by actively adapting the duty cycle of a node according to the likelihood that the node will experience an event of interest in the near future (i.e., the “spatio-temporal event probability” (STEP) at the node, which will be described in more detail below). It should be appreciated that the precise definition of an “event” will depend on the application to which the WSN is being put. Furthermore, some applications may require multiple event types to be defined. In the illustrative context of an object detection and tracking application, by way of example, an “event” may be defined as the presence of an object of interest (for example, a pedestrian). In other words, if an event occurs at a node, an object of interest exists within the sensing field of the node. The PDCA scheme increases the duty cycle at a node if it is likely that the node will soon experience an event and decreases the duty cycle otherwise. In other words, the PDCA scheme increases the duty cycle of a node if the STEP at the node goes up and decreases the duty cycle appropriately if the STEP goes down, as described in more detail below.

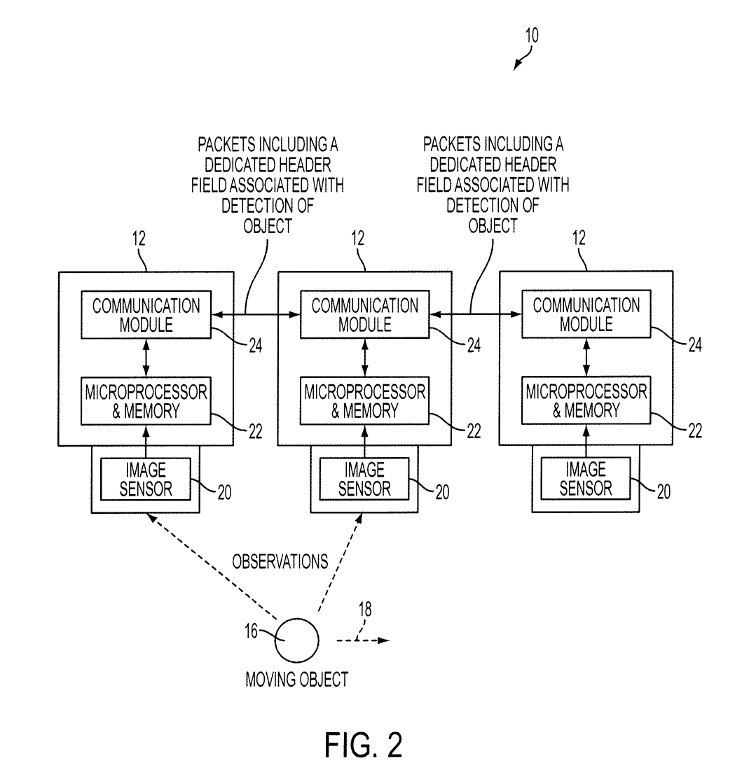

Several wireless, camera-based sensor nodes (nodes) 12, which may be utilized in the illustrative WCNs 10 of the present disclosure, are illustrated in FIG. 2 tracking an object of interest 16 (that is moving in a direction 18). Each node 12 may illustratively include an image sensor 20, a microprocessor and memory circuit 22, and a communication module 24. In other embodiments, a computing device external to the node 12 (typically including a microprocessor, memory, and communication circuitry) may receive and process the raw image data from the image sensor(s) 20. The image sensors 20 may illustratively include CCD cameras, CMOS cameras, and/or any other suitable alternatives. The communication module 24 may include a radio having wireless communications capabilities on the MAC layer. The image sensor 20 of each node 12 may capture a raw image and transmit the raw image to the associated microprocessor of the circuit 22. The microprocessor of circuit 22 may then perform a series of tasks (based on procedures embedded in the application layer) including, but not limited to, (a) storing the image captured by the image sensor 20 in the memory of circuit 22, (b) processing the stored image to detect events and to generate analyzed data associated with such events in the stored image (for instance, detecting the presence of the object 16), (c) controlling the associated communication module 24 to transmit and receive information from neighboring nodes 12 on the MAC layer (based on their communication schedules), and (d) controlling overall functions of the node 12.

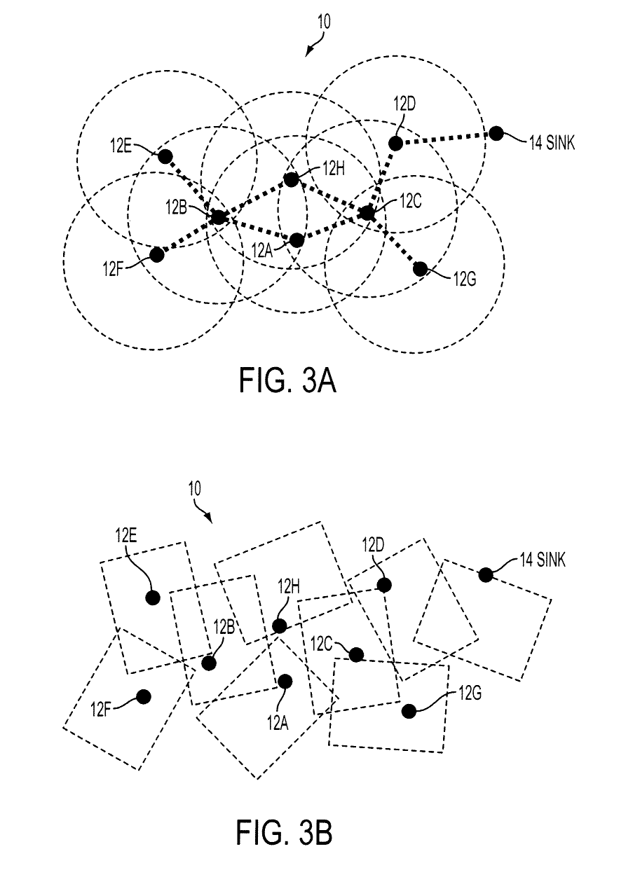

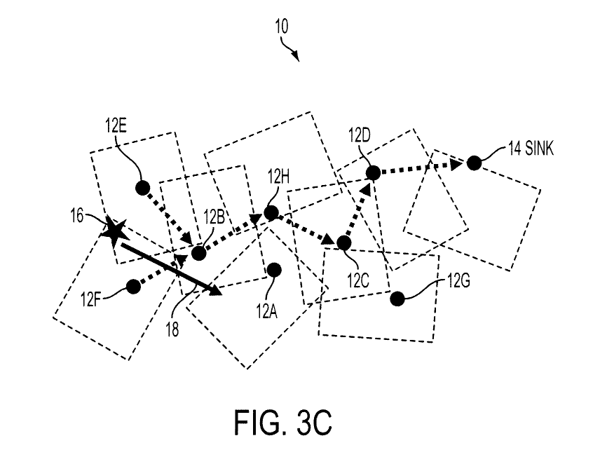

An illustrative embodiment of a WCN 10 comprising a set of randomly deployed nodes 12 (individually labeled 12A-12H) and a base station, or “sink,” 14 is generally shown from a top view in FIGS. 3A-C. In this illustrative embodiment, an event for a node 12 may be defined as the presence of an object of interest 16 within the sensing field of the node 12. Other embodiments, in which the WCN 10 has alternate topologies to those shown in FIGS. 3A-C, are also contemplated. The partially overlapping communications ranges of the nodes 12 are indicated as dotted circles in FIG. 3A, while the partially overlapping sensing fields of the nodes 12, 14 are indicated as dotted rectangles in FIG. 3B. FIG. 3C illustrates the WCN 10 tracking an object of interest 16 (which is visible to a cluster of nodes and is moving in direction 18) and delivering data aggregated within the cluster to the base station 14 through multi-hop communications (along the routing path indicated by the dotted arrows). As shown in FIG. 3C, the nodes 12E, 12F are currently able to see the object 16 and are actively participating in cluster data aggregation (i.e., the nodes 12E, 12F are experiencing an event). Thus, the duty cycle of nodes 12E, 12F is set to a sufficiently high value (e.g., a maximum duty cycle). Since it is likely that the nodes 12A, 12B may soon sense the object 16 (because of an expected future state of the object 16 based on its current motion in direction 18), the duty cycle of nodes 12A, 12B may also be increased in order to achieve a low-latency condition at these nodes prior to the object 16 actually becoming visible. Nodes 12B, 12C, 12D, 12H are actively participating in delivering the aggregated data to the base station 14. Thus, the duty cycle of nodes 12B, 12C, 12D, 12H is also set to a sufficiently high value (e.g., a maximum duty cycle) so that packets containing information regarding the object 16 can be delivered to the base station 14 quickly and reliably. Finally, the remaining node 12G is relatively distant to an event of interest, and the PDCA scheme decreases the duty-cycle of node 12G accordingly.

When an event of interest occurs at a node 12, the PDCA scheme notifies the communication neighbors of the node 12 of the event in order to prepare for a possible upcoming increase in radio traffic. In one illustrative embodiment, a node 12 currently detecting an event may alert its communication neighbors to the occurrence of the event by setting a dedicated bit in the MAC header of packets it transmits. Such a dedicated bit is referred to herein as an Explicit Event Notification (EEN) bit. It is also contemplated that, in alternative embodiments, a dedicated 2-bit field may be used in the MAC header. In addition to the EEN bit, such alternative embodiments may also include an Explicit Event-Routing Notification (EERN) bit that is used to indicate whether the node 12 transmitting the packet header is currently transferring event-related data. Since MAC layer protocols are generally not responsible for acquiring direct sensor measurements, the PDCA scheme provides an interface to the application layer that allows it to notify the MAC layer that the EEN bit of all outgoing packets should be set when an event of interest is within the sensing field of the node 12 (and, in the alternative embodiments employing the dedicated 2-bit field, that the EERN bit of all outgoing packets should be set when the node 12 is transmitting event-related data).

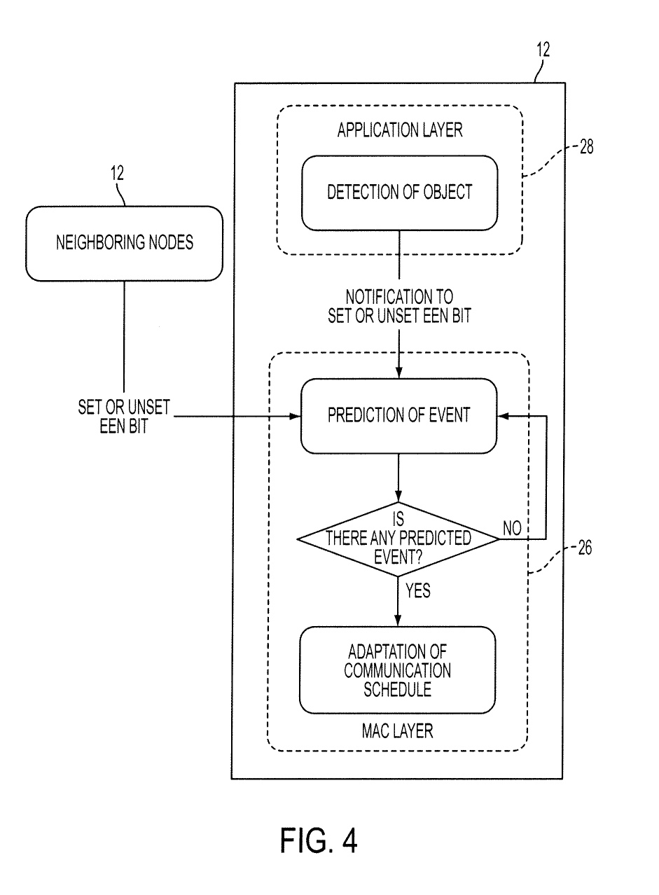

An overview of this interaction between the MAC layer 26 and the application layer 28 for one of the nodes 12 is generally illustrated in FIG. 4. The application layer 28 of the node 12 notifies the MAC layer 26 of whether an event has been detected in the sensing field of the node 12, so that the MAC layer 26 may set or unset the EEN bit of the header in packets it transmits. At the same, if any neighboring nodes 12 detect events, such neighboring nodes 12 also notify the node 12 of the events in the form of set EEN bit in header of packets received by the MAC layer 26. As explained in more detail below, the node 12 may predict whether it will experience an event in the near future based on whether the EEN bits it receives are set or unset. If an event is predicted to occur in the sensing field of the node 12, the MAC layer 26 may adapt the communication schedule of the node 12 (with respect to the duty cycle of its radio) in order to communicate with neighboring nodes 12 in a more efficient manner.

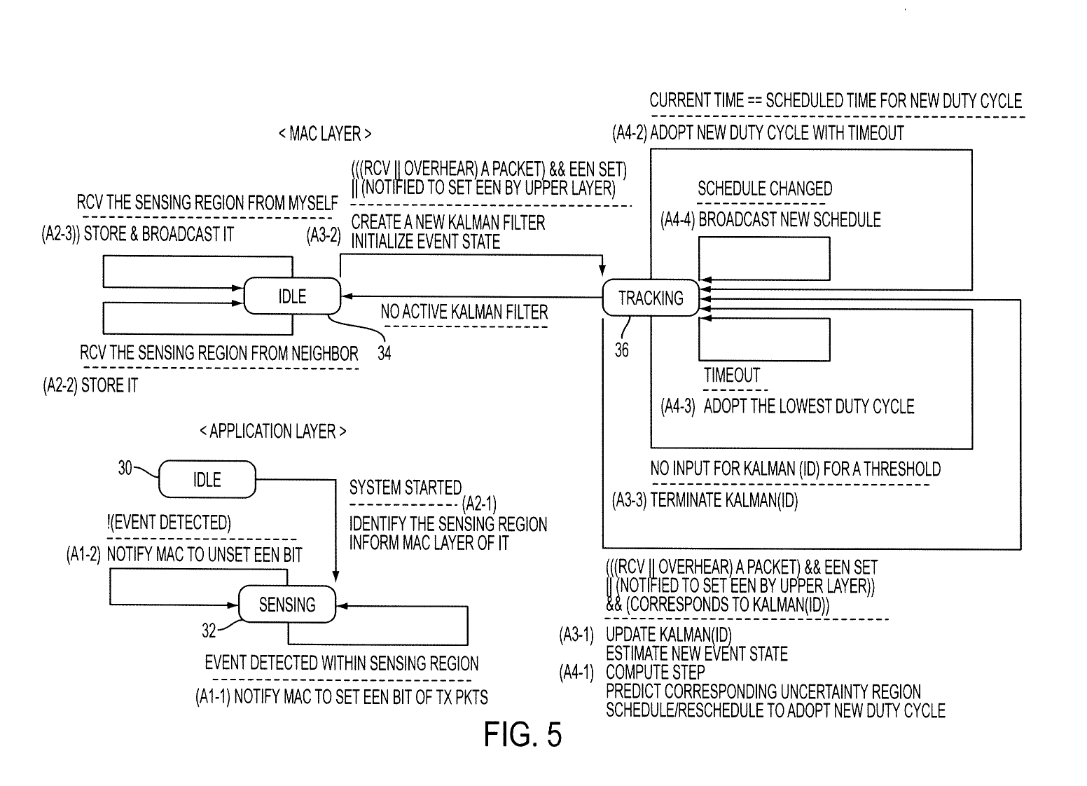

A detailed state transition diagram for the MAC layer 26 and the application layer 28 of a node 12 in this illustrative embodiment is shown in FIG. 5. The application layer 28 has two possible states: an idle state 30 and a sensing state 32. Before the WCN 10 begins operation, the application layer 28 is in the idle state 30. Once the WCN 10 beings operating, the state of the application layer 28 transitions to the sensing state 32 (described in more detail below with reference to Algorithm 2). In the sensing state 32, the application layer 28 of the node 12 attempts to detect events in its sensing field. If an event of interest is detected, then the application layer 28 of node 12 notifies the MAC layer 26 of node 12 to set its EEN bits (described in more detail below with reference to Algorithm 1).

The MAC layer 26 also has two possible states: an idle state 34 and a tracking state 36. Until the MAC layer 26 of a node 12 is notified of the detection of an event by either its own application layer 28 or by a neighboring node 12 via a set EEN bit, the MAC layer 26 is in idle state 34. Once the MAC layer 26 receives an event notification, the state is changed to the tracking state 36. In the tracking state 36, the MAC layer 26 performs a prediction of detecting an event in the near future using the STEP at the node 12. Based upon the likelihood of an event occurring in the sensing field of the node 12 in the near future, the MAC layer 26 adapts the communication schedule of the node 12. In other words, the MAC layer 26 refines the duty cycle of its radio based upon the STEP at the node 12, such that communications with neighboring nodes 12 are conducted efficiently with a reduced energy consumption for the WCN 10. These operations of the MAC layer 26 will be described in more detail below with reference to Algorithms 3-5. It should be noted that the indices A1-1, A1-2, . . . , A4-4, in FIG. 5 represent operations depicted in Algorithms 1-4 below.

When a node 12 receives or overhears a packet for which the EEN bit is set, the node 12 is able to “indirectly sense” the event of interest (without necessarily having to “directly sense” the event using its own sensor). In some embodiments, the receiving node 12 may assume that the event is located at the center of the sensing field of the transmitting node 12 with an associated amount of uncertainty, approximated by the region of the transmitting node's sensing field. Referring again to the illustrative embodiment of a WCN 10 (now with reference to FIG. 6), the sensing field of each wireless camera node 12 may be defined as a viewing frustum 40 where an object can be perceived with an acceptably sharp focus in the image plane 42. The viewing frustum 40 is bounded by sides 44 which radiate from an optical center 46 within the camera and by a near plane 48 and a far plane 50 which represent the limits of an acceptably sharp focus. Once the viewing frustum 40 has been identified, the center 52 of the sensing field can also be found. Localizing an event in the above manner provides an “extended sensing field” for each node 12 receiving packets with the EEN bit set. It will be appreciated by those of skill in the art that the EEN bit has a functional analogy to a generalized form of Explicit Congestion Notification (ECN), typically used in TCP/IP. The detection of an event by this type of indirect sensing may be taken as an input to a Kalman filter (KF). The state estimation procedures performed by each node 12 in the illustrative embodiment of a WCN 10 using KF-based tracking of an event are summarized as pseudocode in Algorithm 1.

Algorithm 1 (Object Tracking Using KF)

```
Application Layer
    If an event of interest is detected within the sensing field then
        (A1-1) Notify MAC layer to set EEN bit of outgoing packets
    Else
        (A1-2) Notify MAC layer to unset EEN bit of outgoing packets
    End if
MAC Layer
    While (1)
        If a packet is received/overheard and EEN bit is set OR
        notified to set EEN bit
        by application layer then
            (A1-3) Set ID as identifier of the node that has activated
            the set EEN bit.
            Kalman(ID)  //calls Algorithm 3
        End if
    End while
```

This indirect sensing approach, using the EEN bit, assumes that each node has information regarding the sensing fields of its communications neighbors. In some embodiments, this information may be received by each node 12 during an initialization stage of the WCN 10. Since computing the sensing parameters of the nodes 12 is generally beyond the scope of a MAC protocol, the present disclosure assumes that (after some initial calibration procedure) this information is available to the application layer. The application layer may then deliver this information to the MAC layer in the form of a triple (ID; z; R), where ID identifies a node 12 (“self” indicating the local node address), z corresponds to the center 52 of the sensing field 40 of the node 12, and R is an ellipsoid that approximates the sensing field 40 of the node 12. The node 12 may then broadcast this information to its one-hop communication neighbors. The nodes 12 that receive these initialization messages may store them in a list of neighboring nodes 12 within the MAC layer protocol. An exemplary initialization process performed by each node 12 in the illustrative embodiment of a WCN 10 is summarized as pseudocode in Algorithm 2.

Algorithm 2 (System Initialization)

```
Application Layer
    If sensing information is identified with respect to neighboring
    nodes then,
        (A2-1) Inform MAC layer of (ID; z; R)
    End if
MAC Layer
    If sensing information is received then,
        (A2-2) Store (ID; z; R)
            If (ID == self)
                (A2-3) Broadcast (ID; z; R)
            End if
    End if
```

As noted above, the prediction of events may be carried out using the spatio-temporal event probability (STEP) at a node 12; this procedure will be described mathematically in the following paragraphs. Given an event j at a time instant tₖ, the STEP distribution, denoted as Sₖ^{j}, is given by the uncertainty of the predicted position of the target event at time tₖ₊₁=tₖ+δₖ where δₖ is the expected time interval before the next sensor measurement. That is, with the predicted position of the target event given by pₖ^{j}, the STEP is given by Sₖ^{j}=Pr(pₖ^{j}). It should be noted that the subscript of STEP Sₖ^{j} and the predicted position pₖ^{j} is k , not k+1, because the subscript indicates the time when the prediction is made. The STEP distribution is updated whenever a new measurement is obtained by the node 12 either by direct or indirect sensing.

It is reasonable to assume that as an event is being tracked, each node 12 will acquire multiple observations of the event. Returning to the example of an event being associated with the detection of an object 16 moving in a direction 18, each node 12 of the illustrative WCN 10 will generally acquire multiple observations of the location of the object 16. Each such measurement may be characterized as an expected value for the location of the object 16, along with an associated uncertainty in the form of a covariance matrix. These measurements, acquired sequentially as the object 16 is being tracked, may be used in a recursive framework to predict what nodes 12 are most likely to see the object 16 in the near future. In some embodiments, this recursive framework may be embodied as a KF framework, similar to that described in H. Medeiros et al., “Distributed Object Tracking Using a Cluster-Based Kalman Filter in Wireless Camera Networks,” 2 IEEE Journal of Selected Topics in Signal Processing 448-463 (2008), the entire disclosure of which is expressly incorporated herein by reference.

In the illustrative embodiment, each node 12 that is currently engaged in observing and tracking an object of interest 16 will create a state vector for the object 16. In most cases, the state vector at a node 12 will be initialized with object information received from a neighboring node 12. Subsequently, as the node 12 itself begins to observe the object 16, the Kalman equations may be used to update the state vector. This updated state vector may then be used by the node 12 to make a prediction about where the object 12 will appear when it departs the sensing field 40 of the current node 12. The state vector may illustratively comprise a four-dimensional (4D) vector that consists of both the position (xₖ, yₖ) and the velocity (\dot{x}ₖ, \dot{y}ₖ) of an event at a discrete time instant k. In other words, the state vector may be given by:

xₖ=[xₖ yₖ \dot{x}ₖ \dot{y}ₖ]^{T} (1).

Using this state vector, the system dynamics may be modeled by:

$${x}_{k + 1} = {[ \begin{matrix}{x}_{k} + {δ}_{k} {\dot{x}}_{k} + \frac{{a}_{x}}{2} {δ}_{k}^{2} \\ {y}_{k} + {δ}_{k} {\dot{y}}_{k} + \frac{{a}_{y}}{2} {δ}_{k}^{2} \\ {\dot{x}}_{k} + {a}_{x} {δ}_{k} \\ {\dot{y}}_{k} + {a}_{y} {δ}_{k}\end{matrix} ]}^{T} , \qquad ( 2 )$$

where δₖ represents the time elapsed between two observations of the object 16 (i.e., if measurement k was taken at time tₖ, measurement k+1 is acquired at time tₖ₊₁=tₖ+δₖ) and the event acceleration (aₓ, a_{y}) is modeled as white Gaussian noise with covariance matrix Q. The systems dynamics may also be represented as:

xₖ₊₁=Fₖxₖ+Wₖwₖ (3),

where:

$$\begin{matrix}{F}_{k} = [ \begin{matrix}{I}_{( 2 \times 2 )} & {δ}_{k} {I}_{( 2 \times 2 )} \\ {0}_{( 2 \times 2 )} & {I}_{( 2 \times 2 )}\end{matrix} ] , & ( 4 ) \\ {W}_{k} = {[ \begin{matrix}\frac{{δ}_{k}^{2}}{2} {I}_{( 2 \times 2 )} & {δ}_{k} {I}_{( 2 \times 2 )}\end{matrix} ]}^{T} , & ( 5 )\end{matrix}$$

and wₖ=[aₓ a_{y}]^{T} is the process noise vector with covariance matrix Q. The measurements utilized by the PDCA scheme are given by the approximated position of the event of interest. Thus, the measurement model may be described by:

zₖ=Hxₖ+vₖ (6),

where H=[I_{(2×2)} 0_{(2×2)}] is the observation matrix and vₖ is the measurement noise, assumed to be white Gaussian noise with covariance matrix Rₖ.

In embodiments where a measurement is received along with its corresponding time stamp and a relatively tight synchronization is maintained among nodes 12, a reasonably precise measurement time may be obtained and δₖ may be accurately computed. In other embodiments, where the measurement does not include a corresponding time stamp, an estimate of the measurement time may still be obtained using the time stamp embedded in the packet. Furthermore, the received measurement itself is a rough approximation of the actual position of the event, and inaccuracies caused by small time differences between the nodes 12 are therefore relatively negligible. In addition, synchronous MAC protocols generally employ a reasonably tight synchronization scheme for proper operation, at least locally among neighboring nodes, and any time jitter in receiving measurements may be reasonably ignored.

Using \hat{x}_{k|k-1} and \hat{x}_{k-1|k-1} as the predicted and previously estimated state vectors, respectively, and using P_{k|k-1} and P_{k-1|k-1} as the predicted and previously estimated covariance matrices, respectively, the time update equations of the KF may be given by:

\hat{x}_{k|k-1}=Fₖ\hat{x}_{k-1|k-1} (7),

P_{k|k-1}=FₖP_{k-1|k-1}Fₖ^{T}+WₖQWₖ^{T} (8),

and the measurement update equations for the KF may be given by:

Kₖ=P_{k|k-1}H^{T}(HP_{k|k-1}H^{T}+Rₖ)⁻¹ (9),

\hat{x}_{k|k}=\hat{x}_{k|k-1}+Kₖ(zₖ−H\hat{x}_{k|k-1}) (10),

P_{k|k}=(I−KₖH)P_{k|k-1} (11),

where Kₖ denotes the Kalman gain. An illustrative KF update function, which may be called by the state estimation algorithm (Algorithm 1) performed by each node 12, is summarized in pseudo-code as Algorithm 3 and described below.

Algorithm 3 (KF Update Function)

```
Function: Kalman(ID)
    If the measurement zₖ(ID) belongs to the predicted spatial uncertainty
    region of an existing event j, A_{α}(pₖ^{j}), then
        (A3-1) Update KF and estimate new event state with input
(zₖ(ID),Rₖ(ID),δₖ)
    Else
        (A3-2) Create a new KF and initialize event state
    End if
    If no measurement received that belongs to the predicted spatial
    uncertainty region of an existing event j, A_{α}(pₖ^{j}), for a time period
    of t > Tₜₕᵣₑₛₕ
        (A3-3) Terminate the KF
    End if
```

When an event is detected at time instant tₖ within the extended sensing field of a node 12, a new measurement zₖ is provided to the tracking algorithm. As previously discussed, a measurement may be the result of a node 12 directly sensing an event or indirectly sensing the event by receiving a packet having the EEN bit set. Since information about the sensing fields 40 of neighboring nodes 12 has been shared locally in the WCN 10 (during initialization, according to Algorithm 2), the mean location (z) of the event, as well as its corresponding covariance matrix (R), may be inferred based on the ID value of the node 12 that transmitted the set EEN bit (or based on the node's own sensing parameters where ID==self). As described above, the mean location may be considered the center 52 of the sensing field 40 of the measuring node 12, and the covariance matrix may be considered a region approximating the sensing field 40 of the measuring node 12. If no event is currently being tracked by a node 12 receiving a new measurement zₖ, a new KF is instantiated and initialized.

Alternatively, if an instance of a KF already exists at the node 12, the node 12 must determine whether the new measurement zₖ relates to an event currently being tracked or to the first occurrence of a new event. This determination is a multi-target tracking problem which becomes even more difficult due to the sensing resolution of the MAC layer. Since this resolution is provided solely by the location of the nodes 12 and their corresponding sensing ranges in the illustrative WCN 10, the sensing resolution of the MAC layer is relatively low regardless of the type and precision of the camera used. The illustrative embodiment avoids this multi-target tracking problem by assuming that multiple events in the WCN 10 are always adequately distant from one another to be distinguishable by the nodes 12. In determining whether a new measurement zₖ corresponds to a previously detected event or to a new event, the PDCA scheme defines the predicted position of an event j at time tₖ as:

$${p}_{k}^{j} = [ \begin{matrix}1 & 0 & 0 & 0 \\ 0 & 1 & 0 & 0\end{matrix} ] {x}_{k + 1 \vert {k}^{′}}^{j} , \qquad ( 12 )$$

where pₖ^{j} corresponds to the predicted x and y coordinates of the event j (not including its velocity). As the time between observations (δₖ₊₁) is not known at time tₖ, the prediction may be carried out using a pre-defined δₖ₊₁ (which may be set based on one or more parameters of the nodes 12, such as their sensing intervals). The corresponding predicted spatial uncertainty region of the event A_{α} (pₖ^{j}) is the region that satisfies Pr(pₖ^{j})≧α, where the parameter α defines the confidence of the uncertainty region (i.e., the predicted spatial uncertainty region corresponds to an area in the (x, y) plane where the target can be found with probability greater than or equal to α). In these terms, the illustrative embodiment assumes that the predicted spatial uncertainty region of the event j does not overlap with the predicted spatial uncertainty regions of any other existing events l≠j (i.e., ^{∀}l≠j: A_{α}(pₖ^{j})∩A_{α}(pₖ^{l})=Ø). Furthermore, in the illustrative embodiment, the parameter α is set small enough so that the next actual consecutive measurement zₖ^{j}(h) of the event j by node h at time tₖ is generally detected within the predicted spatial uncertainty region A_{α}(pₖ^{j}).

Under these assumptions of the illustrative embodiment, a node 12 receiving a new measurement zₖ^{j}(h) within the previously predicted spatial uncertainty region A_{α}(pₖ^{j}) for some event j, will respond by updating the KF corresponding to the event j and estimating the new state of the event j, as summarized in Algorithm 3. Alternatively, if the new measurement zₖ^{j}(h) is not within the previously predicted spatial uncertainty region A_{α}(pₖ^{j}) of any event currently being tracked, the node 12 will instantiate and initialize a new KF. Finally, as shown in Algorithm 3, if the KF instance responsible for tracking the event j does not receive a new measurement zₖ^{j}(h) for a time period longer than some predefined threshold Tₜₕᵣₑₛₕ, the node 12 will terminate that KF instance (the elapse of the predefined time implying that the event has left the extended sensing field of the node).

The overlapping sensing fields 40 among neighboring nodes in a WCN 10 often result in multiple measurements of the same object 16 being received by a node 12. In such conditions, the KF implemented at the node 12 recursively updates the estimated state of an associated event as these measurements are received. Due to medium access contention and/or processing delays, however, the measurements may not be received at a node 12 in the same order they were actually taken. Despite this possibility, a sophisticated mechanism to resolve such ordering issues is not required because the PDCA scheme substantially alleviates any severe communication contention in advance and because the inaccuracy caused by the relatively low sensing resolution of the MAC layer typically dominates any inaccuracy caused by the out-of-order arrival of measurements. Thus, the illustrative embodiment of the PDCA scheme further assumes that the measurements' order of arrival is the order in which the measurements were actually taken. In other embodiments, each measurement may be provided with a time stamp for appropriate ordering by the nodes 12.

An illustrative duty cycle adaptation procedure, which may be performed by each node 12 whenever a KF instance is updated (per Algorithms 1 and 3), is summarized in pseudo-code as Algorithm 4 and described below.

Algorithm 4 (Duty Cycle Adaptation)

```
While (1)
    If KF is updated for event j at time tₖ then
        (A4-1) Compute STEP Sₖ^{j} for event j at time tₖ
        Predict spatial uncertainty region A_{α}ₘ (pₖ^{j}) for each
        duty cycle level m ε {1, . . . , N}
        Schedule/reschedule to adopt duty cycle dₘ at tₖ₊₁ for node m
    End if
    If current time is almost scheduled time then
        (A4-2) Set d_{c} = dₘ with timeout
    End if
    If timeout is expired then
        (A4-3) Set d_{c} to lowest duty cycle
    End if
    If new schedule is adopted then
        (A4-4) Broadcast new schedule to neighboring nodes
    End if
End while
```

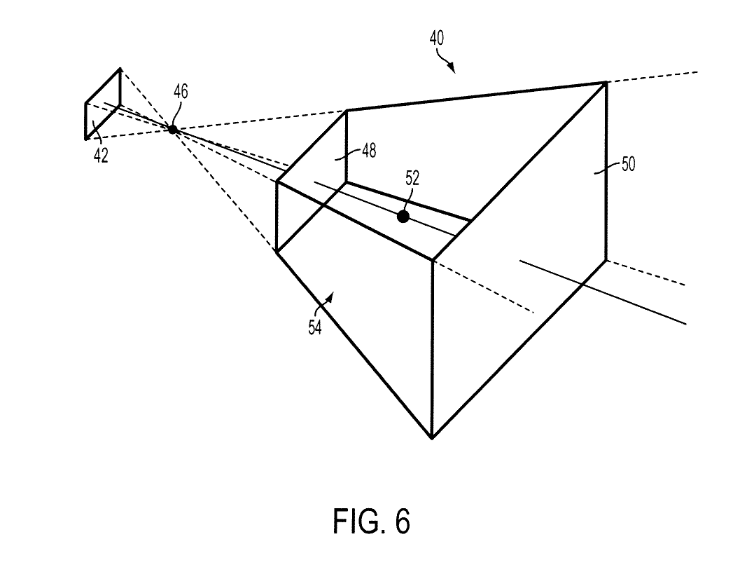

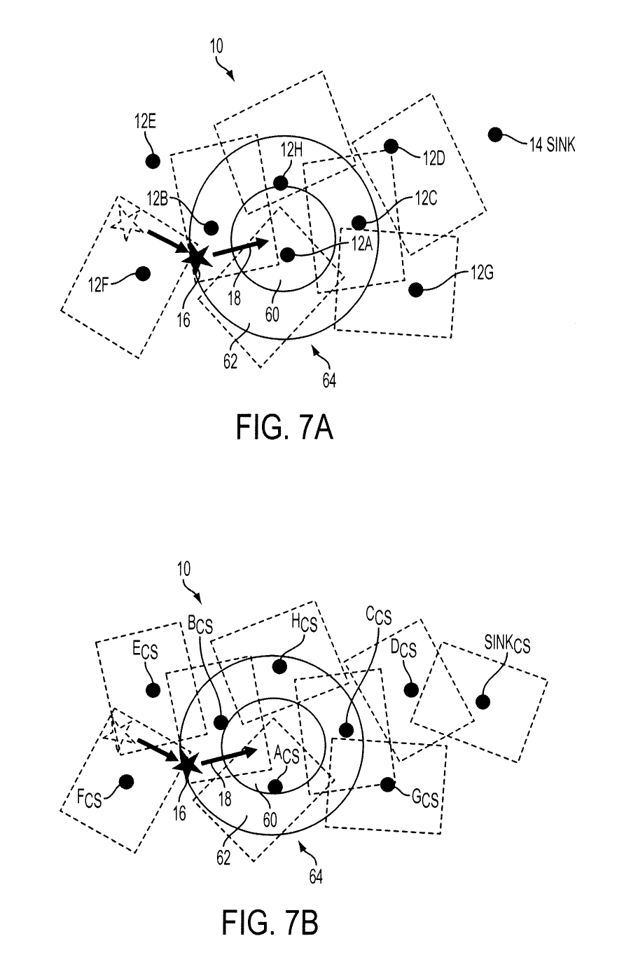

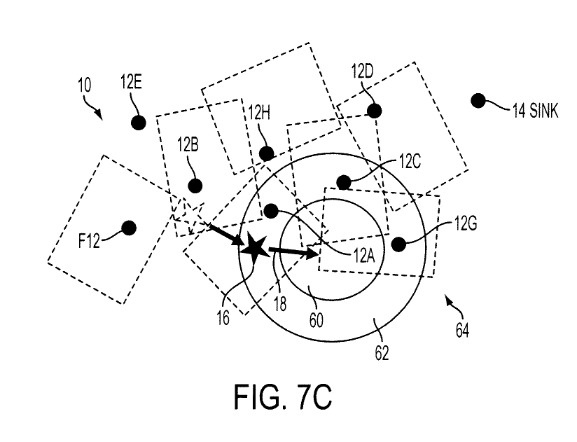

Since the STEP Sₖ^{j} at a given time instant is distributed over a continuous space, the uncertainty region may be divided into sub-regions, each corresponding to a particular of duty cycle level. For instance, in an embodiment in which the PDCA scheme includes N duty cycle levels (d₀, d₁, . . . d_{N}, with d_{N} being the highest duty cycle), the uncertainty region A_{α}(pₖ^{j}) may be divided into N sub-regions, A_{α}_{ₘ}(pₖ^{j}), m∈{1, . . . , N}, that each satisfy Pr(pₖ^{j})≧αₘ, where α₁<α₂< . . . <α_{N}. Each node 12 that is predicted to be within an ellipsoidal region between A_{α}_{ₘ₊₁}(pₖ^{j}) and A_{α}_{ₘ}(pₖ^{j}) at a given time may adjust its duty cycle to dₘ for that time. This division of the STEP distribution into sub-regions will result in an onion-like stratification of duty cycle levels, as illustrated in FIGS. 7A-C. In most embodiments, a relatively small number of duty cycle levels (e.g., 3 to 5) will be sufficient for the PDCA scheme. In the illustrative embodiment of FIGS. 7A-C, the PDCA scheme has three duty cycle levels (i.e., N=3), corresponding to region 60, region 62, and region 64.

It should be noted that the illustrative PDCA scheme is based on the sensing regions 40 of the nodes 12, rather than their geographical positions, allowing the MAC protocol to be applied to directional sensor networks (e.g., camera networks). Thus, while the points in FIG. 7A indicate the physical location of each node 12A-H, the points in FIG. 7B indicated the center 52 of the sensing region 40 of each node 12A-H (with subscript “cs”). As shown in FIGS. 7A and 7B, the center 52 of the sensing field 40 of node 12A is within region 60, meaning that node 12A will have the highest duty cycle, d₃ in the illustrative embodiment. Meanwhile, the centers 52 of the sensing fields 40 of nodes 12B, 12C, and 12H are within region 62, meaning that nodes 12B, 12C, 12H will have the intermediate duty cycle, d₂, and the remaining nodes 12D-12G will have the lowest duty cycle, d₁.

In Algorithm 4, the current duty cycle level of a node 12 is denoted d_{c},c∈{1, . . . , N}, where the corresponding node 12 is currently in the STEP sub-region between A_{α}_{_{c+1}}(pₖ^{j}) and A_{α}_{_{c}}(pₖ^{j}). Whenever a STEP update occurs, the node 12 may compute a new duty cycle level dₘ and schedule a duty cycle modification for time tₖ₊₁=tₖ+δₖ′. At the scheduled time tₖ₊₁, the node 12 will adopt the new duty cycle level dₘ and broadcasts its new schedule to neighboring nodes 12 (so that they are aware of the time periods during which the broadcasting node 12 will be available). Unlike the occurrence of an event of interest, the disappearance of an event will not trigger immediate communication traffic among nearby nodes 12. Instead, the disappearance of an event may be inferred by the absence, over a period of time, of packets having the EEN bit set. Thus, as shown in Algorithm 4, duty cycle adaptation is carried out using a soft state approach: whenever a duty cycle modification occurs, a timeout period is set and, upon the expiration of the timeout period, a node 12 assumes that the event of interest has left its extended sensing field and resets its duty cycle to the lowest level, d₁.

The illustrative embodiment of a WCN 10 engaged in tracking an object 16 (moving in direction 18) at times tₖ and tₖ′, respectively, is shown in FIGS. 7A-C. Once again, the regions 60-64 (divided by solid circles) indicate exemplary stratified STEP sub-regions, corresponding to varying duty cycle levels. If the event of interest, initially detected by node 12F, moves into the sensing field 40 of node 12B (as shown in FIGS. 7A and 7B) and triggers a packet transmission, the EEN bit will be set in the packets transmitted by node 12B, thereby informing nodes 12A, 12E, 12H of the occurrence of the event. Upon the reception of such a packet from node 12B at time tₖ, a KF will be created, initialized, and updated at each of nodes 12A, 12E, 12H, due to this indirectly sensed measurement. Nodes 12A, 12E, 12H will then compute the current STEP Sₖ^{j} with respect to the centers 52 of their respective sensing fields 40.

The STEP computed by node 12A at time tₖ, based on messages received from node 12B, is illustrated in FIGS. 7A and 7B. At this moment, the node 12A predicts that it will be within region 60 during its next measurement (i.e., it is very likely to detect the object 16) and, consequently, schedules the adoption of the highest duty cycle level d₃ at tₖ₊₁. At a subsequent time instant tₖ′, illustrated in FIG. 7C, the node 12A acquires a measurement of the object 16 and computes a new STEP Sₖ^{j}. At this moment, the node 12A predicts that it will be within the new region 62 during its next measurement (i.e., it is relatively less likely to detect the object 16, which is moving away from its sensing field 40, as reflected in the new STEP) and, consequently, schedules the adoption of the intermediate duty cycle level d₂. Since each node 12 computes its own STEP independently, based not only on its own measurements but also on the messages received from neighboring nodes 12, the STEP Sₖ^{j} computed at different nodes 12 may differ slightly. In spite of small discrepancies in practice, the STEPs computed by multiple nodes 12 are all approximations of the distribution of the event position and will, therefore, often be very similar. If a node 12 is tracking multiple events (e.g., using multiple KF instances), the node 12 may be located within more than one predicted uncertainty region 60-64. In some embodiments, the uncertainties from multiple events may be integrated using different approaches. In the illustrative embodiment, however, the PDCA scheme simply chooses the region 60-64 that corresponds to the higher duty cycle.

Once a node 12 has detected an event of interest and computed a new duty cycle level, the frame length of the node 12 is incremented or decremented exponentially, in the illustrative embodiment. For instance, where T₁ is the frame length of the lowest duty cycle corresponding to d₁, and M is the base of an exponentially-varying frame length, then the length of a current frame, T_{c}, corresponding to d_{c}, may be represented as:

$${T}_{c} = \frac{{T}_{1}}{{M}^{i}} , \qquad ( 13 )$$

where i∈{1, . . . , N}, N denoting the number of duty cycle levels, and M ∈ N* (i.e., a positive integer). It is contemplated that M could be any number in the PDCA scheme. If the frame length changes by doubling or trebling, for example, M will be two or three, respectively. This exponentially-varying adaptive frame method guarantees that any pair of nodes 12 is able to communicate, even if the nodes operate at different duty cycles. For instance, given two nodes nᵢ and nⱼ operating at duty cycle levels dᵢ and dⱼ (i<j) that are both initially active at time t₀, node nᵢ will wake up at times t₀+kTᵢ(k ∈ N), and node nⱼ will wake up at times t₀+ITⱼ(l ∈ N). Whenever

$$\frac{l}{k} = {M}^{j - i} ,$$

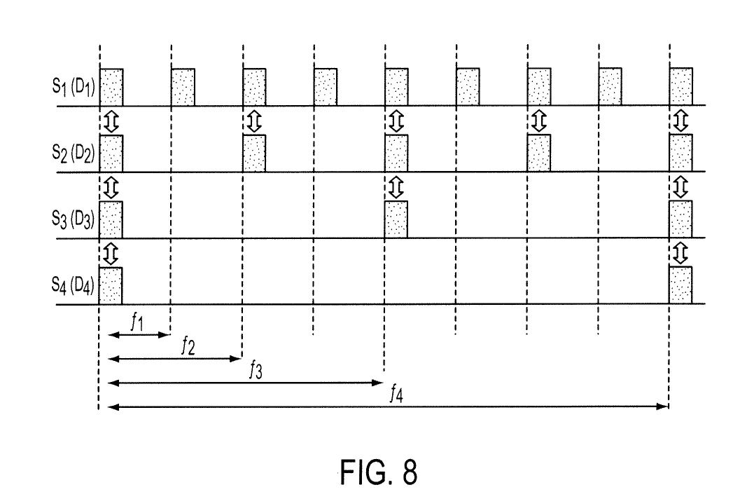

the active intervals of both nodes will coincide. As a consequence, every node 12 in the WCN 10 is able to communicate with its immediate neighbors, at least during the basic frame times t_{bf}, which are the active periods corresponding to the lowest possible duty cycle level d₁. The exponentially varying frame lengths of an illustrative embodiment using four different duty cycle levels (d₁ to d₄) are shown in FIG. 8. Schedule S₁ (with duty cycle d₁) has a frame length of f₁, while schedules S₂ (d₂), S₃ (d₃), and S₄ (d₄) have the frame lengths of f₂, f₃, and f₄, respectively. The exponential relation between these frame lengths may be represented a: f₄=(2¹)*f₃=(2²)*f₃=(2³)*f₁.

After the a node 12 determines it should adopt a new duty cycle level dₘ at time tₖ₊₁, the node 12 should also employ a mechanism to allow this modification without desynchronizing its schedule from those of neighboring nodes 12. Since tₖ₊₁ may not coincide with the beginning of a new frame, the node 12 may determine a different time to actually start the next frame using the new schedule. Using t_{c} as the current time, t_{cf} as the time that the current frame started, t_{bf} as the time when the previous basic frame started, and t_{nf} as the time when the next frame should start according to the current schedule, if a node 12 decides, at time t_{c}, to change its duty cycle to a different level dₘ, the node 12 will schedule the beginning of the next frame to t_{nf}′=t_{c}+Δ, where Δ is the residual time to the beginning of the next frame:

$$Δ = min [ U ( \frac{{T}_{1}}{{M}^{{d}_{m}}} ) - ( {t}_{c} - {t}_{{t}_{bf}} ) ] , \qquad ( 14 )$$

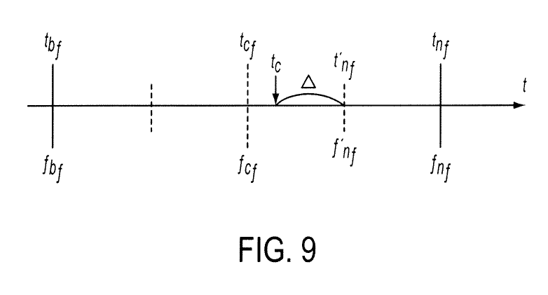

subject to Δ>0, where U ∈ {1, . . . , M^{d}^{ₘ}}. Since all the parameters in Equation (14) are known and M^{d}^{ₘ} is relatively small, this minimization problem may be quickly solved by searching the possible values of U. Referring now to FIG. 9, the solid vertical lines illustrate the beginning of the active periods of the current schedule and the dashed vertical lines illustrate the beginning of the active periods of the new schedule to be adopted. If the parameters in this case are M=2 and N=5, the current duty cycle level of the node 12 is d_{c}=1, and, at time t_{c}, the node 12 decides to increase its duty cycle to dₘ=2, the parameter U will be chosen as the minimum between 1 and M^{d}^{ₘ}=2² that satisfies Δ>0. In the illustrative example of FIG. 9,

$$( {t}_{c} - {t}_{bf} ) > \frac{{T}_{1}}{2} ,$$

so U is 3. Δ may then be computed by setting U=3 in Equation (14), and the beginning time of the next frame t_{nf}′ may be rescheduled accordingly.

The presently disclosed PDCA scheme is designed to have a plug-in functionality for synchronous MAC protocols in event-driven WSNs. As discussed above, any communication between pairs of nodes 12 that may have different schedules should take place during the overlap in their active periods, which will be the active periods of the node 12 that has the lowest duty cycle among them (not necessarily d₁). The computation of the active periods of a node 12 may be facilitated by assigning frame numbers to the frames within one duty cycle interval, based on their start times. For instance, when N duty cycle levels are used, the maximum number of frames is M^{N}, so the frame numbers may range from 0 to M^{N}−1, with 0 corresponding to the frame that starts at t_{bf} and M^{N}−1 corresponding to the last frame. When a node 12 operates at a lower duty cycle level d_{c} (c<N), not all frame numbers may be used (since there are fewer frames). The frames that do exist may retain their original numbering based on their start times (i.e., if the frame that starts at time t_{cf} at duty cycle level d_{c} is numbered f_{cf}, its number is also f_{cf} at duty cycle level d_{N}, although frame number f_{cf}+1 will not be used at level d_{c}). The next frame number f_{nf} may be represented as:

f_{nf}(f_{cf}+M^{(d}^{_{N}}^{-d}^{_{c}}⁾)mod M^{d}^{_{N}} (15).

For instance, where M=2, d_{c}=1, and d_{N}=5, the next frame number would be f_{nf}=(f_{cf}+2⁴) mod 2⁵. Since the initial frame is numbered 0, the frame number in this case alternates between 0 and 16. For a node 12 with a neighboring node 12 who's current duty cycle level is d_{c}^{peer}, the active periods of both nodes 12 will overlap whenever the following equation holds:

(f_{cf})mod(M^{d}^{_{N}}^{-d}^{_{c}}^{^{peer}})=0 (16).

For successful unicast communications, the nodes 12 should transmit a packet to one another only during such frames. A node 12 may becomes aware of the schedule of its neighboring nodes 12 using the synchronization mechanism described below. In practice, a node 12 may not know the current schedule of some or all of its neighboring nodes 12 (e.g., the schedule of the neighbors that the node 12 knows may be obsolete), particularly when the duty cycle change of a node 12 occurs in the vicinity of a hot spot. In such cases, a significant delay may exist until the change is recognized by other nodes 12 due to severe contention and collisions. Thus, a node 12 may also estimate the schedule of its neighboring nodes 12 by checking in which region of its own STEP the neighbor lies. Various transmission policies may be employed for broadcast communications. In some embodiments, communication may be restricted so that a node 12 may broadcast a packet only if all of its neighboring nodes 12 can receive it (i.e., if Equation (16) holds for all its neighbors). It will be appreciated that this embodiment will incur longer transmission delays for broadcasted packets. In other embodiments, a node 12 may broadcast messages at the earliest time that at least one neighboring node 12 can listen (i.e., as soon as Equation (16) holds for at least one of its neighbors). It will be appreciated that this embodiment may drastically reduce the chance of neighboring nodes 12 overhearing or receiving the packets. The illustrative embodiment of the PDCA scheme employs the latter approach, since neighboring nodes 12 in the vicinity of an event are very likely to have the same as or even higher duty cycles than the subject node 12 and event-related information is usually delay-sensitive.

In the illustrative embodiment of the PDCA scheme, a SYNC message may be broadcast whenever either a schedule change occurs or a periodic SYNC message exchange is needed. Each SYNC packet may illustratively contain (a) the ID of the schedule initiator, (b) the current duty cycle level d_{c}, (c) the residual time to the beginning of the next basic frame, (d) the age of the current schedule, and (e) a 2-bit field for EEN and EERN (discussed in more detail below). The “age” of the current schedule refers to the number of times that the schedule was broadcast by the initiator in periodic exchanges. The illustrative embodiment of the PDCA scheme also employs a global scheduling scheme in the entire network to avoid possible issues related to border nodes (that belong to multiple, disparate schedules). This global scheduling scheme may be implemented by having nodes 12 adopt the “older” schedule. For instance, if S₀ is the initiator of a schedule and a node 12 operating under a schedule initiated by S₀ receives a SYNC packet from a neighboring node 12 with a schedule originated from Sᵢ (where i≠0) or with the same schedule, but with different age, the node 12 will adopts the older schedule.

To reduce possible latency in the delivery of information about an event of interest to the base station 14, the PDCA scheme may also explicitly distinguish the intermediate nodes 12 along the routing path used to deliver this information. As previously discussed, event-detecting nodes 12 are identified by setting the EEN bit in the MAC header of outgoing packets from those nodes 12. To indicate that a node 12 is routing event-related information to the base station 14, on the other hand, the node 12 may set an Explicit Event-Routing Notification (EERN) bit in the MAC header. When a node 12 is the intended recipient of a packet in which the EEN or EERN bit is set, this implies that a prioritized flow that contains information about an event of interest is being routed through the node 12. Thus, upon the reception of this packet, the node sets the EERN bit of all packets to be subsequently transmitted.

As long as a node 12 is part of a routing path, it increases its duty cycle to a pre-defined level d_{N′}, to minimize any end-to-end latency. The level d_{N′}, may be set same as the maximum duty cycle d_{N}, in some embodiments. Referring to the illustrative WCN 10 shown in FIG. 3C, since the nodes 12B, 12H, 12C, 12D, and the base station 14 are along the routing path of the event-related packets, their duty cycles would be increased to d_{N′}, upon the reception of packets originated from nodes 12E or 12F. Membership of a node 12 along a routing path may be implemented as a soft state that must be refreshed periodically by the reception of packets with EERN set. In other words, if a node 12 does not receive a routed packet within a specific period of time, the node 12 will reduce its duty cycle to the lowest level d₁. An illustrative duty cycle adaptation procedure for event information routing, which may be performed by each node 12, is summarized in pseudo-code as Algorithm 5 (the variable isEventRouting indicates that a node 12 is currently part of a routing path).

Algorithm 5 (Fast Delivery of Routing Packets Related to an Event of
Interest)

```
While (1)
    If receive a packet Y from a neighbor and intended recipient and
    (Y .EERN set || Y .EEN set)
        (A5-1) Set isEventRouting with timeout and increase duty cycle
        to d_{c} = d_{N′}
    End if
    If (transmit a packet Y)
        (A5-2) Y .EERN = isEventRouting
    End if
    If (timeout expired)
        (A5-3) Decrease duty cycle to d₁
    End if
End while
```

The illustrative embodiment of the MAC protocol was built by applying the presently disclosed PDCA scheme to a TMAC framework (referred to herein as “P-TMAC”). TMAC is synchronous, adaptive duty cycling MAC protocol (relying on current network conditions) with a fixed frame length. By applying the PDCA scheme to TMAC, the frame length also becomes dynamic, resulting in better adaptivity without any design conflict. The P-TMAC protocol was evaluated, in the context of target tracking (a typical application for event-driven WSNs) on a Castalia simulator. The Castalia simulator is described in A. Boulis, “Castalia: Revealing Pitfalls in Designing Distributed Algorithms in WSN,” SenSys '07: Proceedings of the 5th Int'l Conf. on Embedded Networked Sensor Sys. 407-408 (2007), the entire disclosure of which is expressly incorporated herein by reference. In particular, performance of the P-TMAC protocol was simulated with a WCN consisting of 60 TelosB nodes, each equipped with a camera deployed randomly under the ceiling and viewing downwards in a 25 m×45 m area. A randomly moving object was assumed to exist in the network during one third of the total simulation time (to accommodate, to some extent, both cases of rare and frequent event occurrence).

The simulated performance of P-TMAC was compared with two other existing adaptive MAC protocols: AMAC and TMAC. The basic frame length, L, of these MAC protocols were all set to be 1220 ms with 30 ms of active period, resulting in a 2.46% basic duty cycle. P-TMAC and AMAC were each allowed to change their frame lengths among L, L/2, L/4, and L/8 (due to the property of exponentially-varying frame length). To provide a baseline for performance evaluation, four TMACs of differing frame lengths were also evaluated. Specifically, TMAC protocols having frame lengths corresponding to 2.5%, 4.9%, 9.8%, and 19.7% duty cycles and named TMAC-0, TMAC-1, TMAC-2, and TMAC-3, respectively, were also simulated. The remaining parameters of the simulation are summarized in Table 1 below.

TABLE 1
Summary of Simulation Parameters

| | | |
|---|---|---|
| Transmit Range | ~100 | meters |
| Transmit Power (at 0 dBm) | 35 | mW |
| Receive Power | 38 | mW |
| Sleep Power | 15 | μW |
| Idle Power | 3 | mW |
| Sensing Range | 50 | meters |
| SYNC | 22 | Byte |
| RTS | 14 | Byte |
| CTS | 14 | Byte |
| ACK | 14 | Byte |
| DATA | 44 | Byte |
| Simulation Time | 2400 | seconds |
| Average Object Speed | 3 | meters/sec. |

Furthermore, two types of scenarios were emulated: where the nodes that detect an event of interest report it to a sink node either individually or with collaborative data processing with neighboring nodes. The first scenario (i.e., where each node detecting an event of interest individually reports its measurement) evaluates how well each MAC protocol can handle bursty packets triggered by the event. The second scenario (i.e., where each node detecting an event exchange messages with its neighboring nodes to perform collaborative sensing and processing and then reports the aggregated result) entails even more intensive bursty traffic in the vicinity of the event, creating additional challenges to the MAC protocol employed. The performance characteristics of the MAC protocols in both scenarios were captured using the time-bounded parameter-estimation accuracy (TIBPEA), a QoS metric specifically designed to evaluate event-driven WSNs, in addition to traditional metrics such as latency and throughput. TIBPEA is described in P. J. Shin et al., “A QoS Evaluation Testbed for MAC Protocols for Wireless Camera Networks” 235-242 (2007), the entire disclosure of which is expressly incorporated herein by reference. The TIBPEA QoS evaluation metric is designed based on the observation that, the greater the reliability with which neighboring nodes can communicate with one another, the greater the accuracy of any parameter that must be computed collaboratively. The TIBPEA is computed by using the average percentage of neighboring nodes that successfully reply to a broadcast message within a certain timeout period. The various MAC protocols were also evaluated using traditional metrics such as latency, normalized throughput, and energy consumption. The normalized throughput was computed by dividing the number of packets reported from all nodes to the sink in each MAC protocol by that of TMAC-3, which plays a role of a upper limit.

In the first scenario, each node of the WCN continuously senses the environment with its own sensing interval. Whenever an event of interest is detected by a node during its sensing interval, the node reports its own measurements directly to a sink node of the WCN (e.g., located at an edge of the network). Since the sensing fields of the nodes may overlap, the event may trigger multiple communication flows to the sink node from the vicinity of the event, each communication flow being directed by a simple tree-based routing protocol. The performance of the P-TMAC protocol, the AMAC protocol, and the four TMAC protocols (with different basic duty cycles), described above, were evaluated in terms of latency, normalized throughput, and energy consumption in this first scenario.

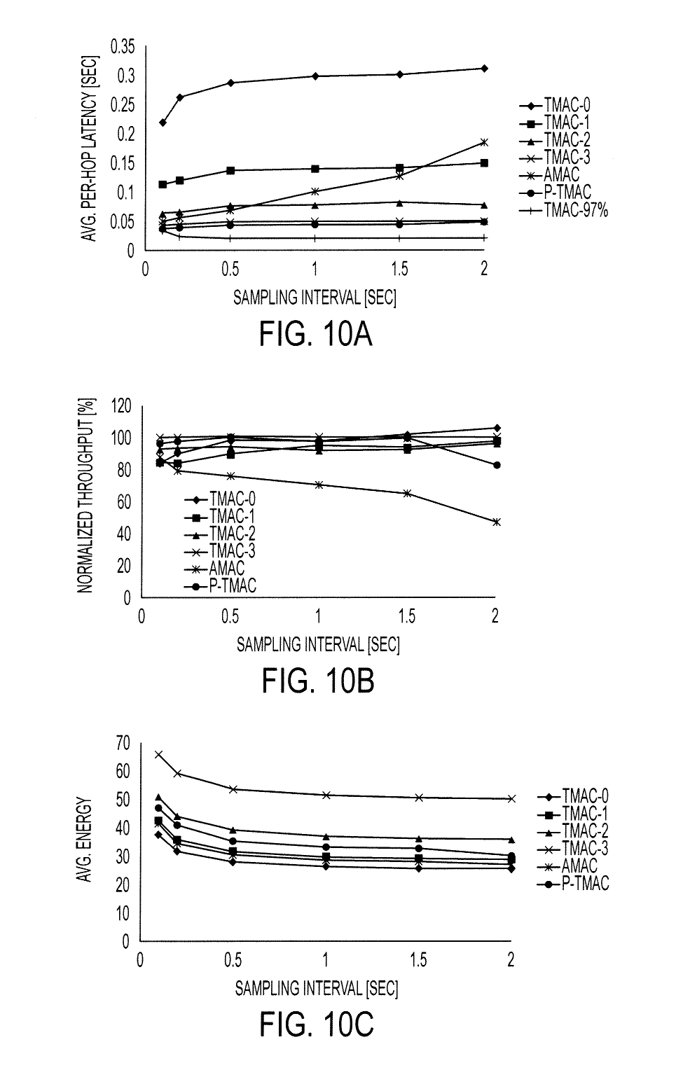

Referring now to FIG. 10A, the simulation results show that P-TMAC achieves very low average per-hop latency, in a similar range to that of TMAC-3, at different sampling intervals. A “sensing round” may be defined as the period during which an event of interest is present in the sensing field of a node. A “link initializing packet” may be defined as the first packet transmitted during each sensing round. Assuming the same object motion, a higher sampling rate causes more packet generation per sensing round, resulting in a lower proportion of link initializing packets to the entire number of packets. TMAC and AMAC are each designed to work best when the number of the link initializing packets is low, due to a low sampling rate and/or slow object movement. As can be seen in FIG. 10A, the average per-hop latency of TMAC-0 and AMAC adversely increases with sampling interval increases, while P-TMAC retains its best performance.

The normalized throughput of each MAC protocol simulation is shown in FIG. 10B. The normalized throughput was computed by dividing the number of packets reported from all nodes to the sink node for each MAC protocol by the same metric of TMAC-3 (which serves as a theoretical upper limit). In terms of throughput, P-TMAC outperforms AMAC, achieving almost the same performance as that of TMAC-3. The primary reason AMAC's throughput decreases as sampling interval increases is the additional communication overhead of control packets (e.g., SYNC, RTS, and CTS) as compared to data packets. P-TMAC and AMAC each broadcast current schedules whenever the schedule of a node changes. Since P-TMAC has a wider range of schedule adaptation than AMAC, this communication overhead is distributed over space. Thus, the negative impact of control packets on nodes around the event has less of an impact in P-TMAC than in AMAC.

While P-TMAC achieves performance metrics similar to TMAC-3 in terms of latency and throughput, P-TMAC's energy consumption is between TMAC-1 and TMAC-2, as shown in FIG. 10C. This implies that P-TMAC improves the tradeoff between energy and latency more effectively than TMAC. Finally, AMAC achieves better efficiency than P-TMAC, but at the cost of performance in terms of latency and throughput, as described above.

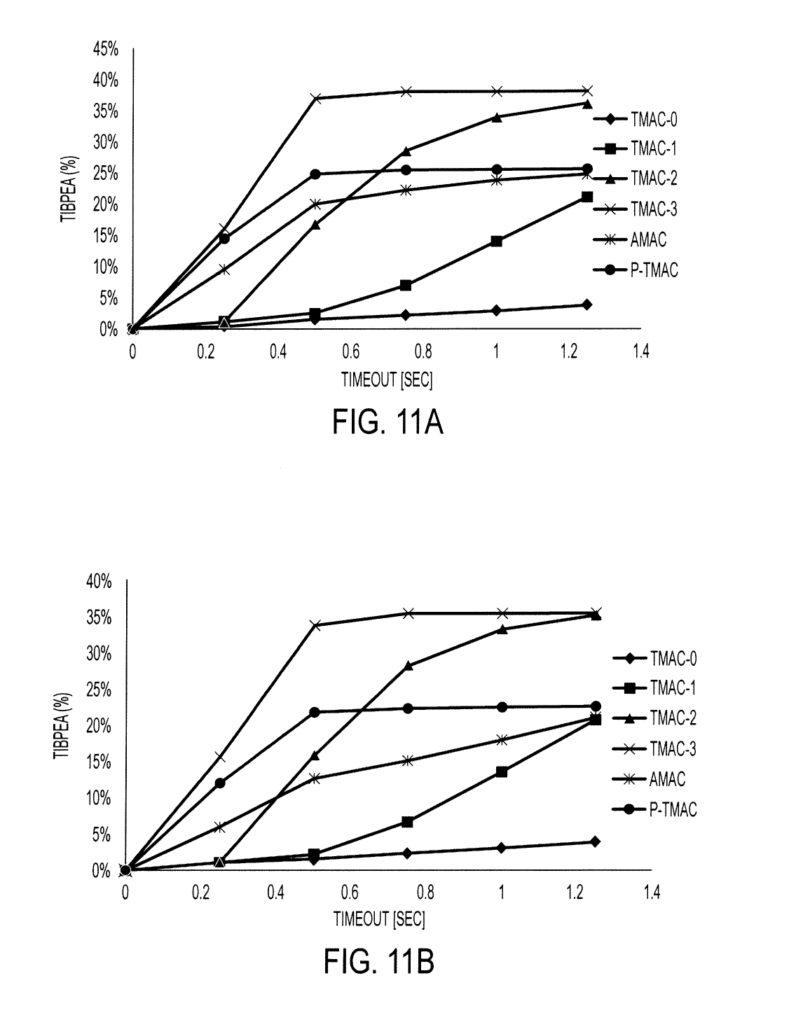

In the second scenario, when a node detects an event of interest, the node attempts to share measurements with neighboring nodes to obtain a more in-depth understanding of the event through collaborative data processing (usually involving distributed algorithms). Referring now to FIGS. 11A and 11B, two sets of simulations with different average target speeds, 3 m/s and 6 m/s, were conducted for the MAC protocols. For each set of simulations, the TIBPEA was measured with different timeout bounds. The P-TMAC protocol outperformed the AMAC protocol, the TMAC-0 protocol, and even the TMAC-2 protocol when the timeout bound was tight (a common situation in event-driven WSNs). The superior performance of P-TMAC, as compared to other MAC protocols, for delay-critical applications satisfies this design goal.

Although certain illustrative embodiments have been described in detail above, variations and modifications exist within the scope and spirit of this disclosure as described and as defined in the following claims.

1. A method for controlling access to a shared communications medium by a plurality of nodes, the method comprising:
predicting, for each node of the plurality of nodes, whether an event will occur within a sensing field of that node at a future time; and
adapting a communications schedule of each node in response to the prediction regarding that node.

2. The method of claim 1, wherein predicting whether an event will occur within a sensing field of each node at a future time comprises predicting whether a camera of each node will observe an object of interest at the future time.

3. The method of claim 1, wherein predicting whether an event will occur within a sensing field of each node at a future time comprises estimating a spatio-temporal event probability at each node of the plurality of nodes.

4. The method of claim 3, wherein estimating the STEP at each node of the plurality of nodes comprises integrating a position uncertainty of an event over the sensing field of each node at the future time.

5. The method of claim 3, wherein estimating the STEP at each node of the plurality of nodes comprises using a recursive parameter estimator.

6. The method of claim 5, wherein using a recursive parameter estimator comprises using one of a Kalman filter and a particle filter.

7. The method of claim 5, further comprising receiving or overhearing, with a first node of the plurality of nodes, a packet from a second node of the plurality of nodes, the packet including a measurement of an event.

8. The method of claim 7, further comprising estimating a new STEP at the first node by updating the recursive parameter estimator using the measurement of the event.

9. The method of claim 7, further comprising initializing a new instance of the recursive parameter estimator when the measurement is not within a predicted uncertainty region for the event.

10. The method of claim 7, further comprising terminating an instance of the recursive parameter estimator after a predefined period of time during which no packets including a new measurement of the event are received or overheard by the first node.

11. The method of claim 10, wherein the communications schedule of the first node is adapted to a lowest duty cycle in response to the termination of the instance of the recursive parameter estimator.

12. The method of claim 1, wherein adapting the communications schedule of each node comprises adjusting a duty cycle of a radio of each node.

13. The method of claim 12, wherein adjusting the duty cycle of the radio of each node comprises determining to which probability subspace of a predicted uncertainty region of an event each node belongs.

14. The method of claim 12, wherein adjusting the duty cycle of the radio of each node comprises exponentially varying a frame length utilized by each radio.

15. The method of claim 1, further comprising transmitting a packet containing a dedicated field, the dedicated field including a first bit indicating whether a node transmitting the packet is currently sensing an event.

16. The method of claim 15, wherein the dedicated field further includes a second bit indicating whether the node transmitting the packet is currently transferring event-related data.

17. One or more non-transitory, computer-readable media comprising a plurality of instructions which, when executed by a processor of a first node, cause the processor to:
predict whether an event will occur within a sensing field of the first node at a future time; and
adapt a communications schedule of the first node in response to the prediction, the communications schedule controlling access by the first node to a communications medium shared between a plurality of nodes.

18. The one or more non-transitory, computer-readable media of claim 17, wherein predicting whether an event will occur within a sensing field of the first node at a future time comprises predicting whether a camera of the first node will observe an object of interest at the future time.

19. The one or more non-transitory, computer-readable media of claim 17, wherein predicting whether an event will occur within a sensing field of the first node at a future time comprises estimating a spatio-temporal event probability at the first node.

20. The one or more non-transitory, computer-readable media of claim 19, wherein estimating the STEP at the first node comprises integrating a position uncertainty of an event over the sensing field of the first node.

21. The one or more non-transitory, computer-readable media of claim 19, wherein estimating the STEP at the first node comprises using a recursive parameter estimator.

22. The one or more non-transitory, computer-readable media of claim 21, wherein using a recursive parameter estimator comprises using one of a Kalman filter and a particle filter.

23. The one or more non-transitory, computer-readable media of claim 21, wherein the plurality of instructions further cause the processor to receive or overhear a packet from a second node of the plurality of nodes, the packet including a measurement of an event.

24. The one or more non-transitory, computer-readable media of claim 23, wherein the plurality of instructions further cause the processor to estimate a new STEP at the first node by updating the recursive parameter estimator using the measurement of the event.

25. The one or more non-transitory, computer-readable media of claim 23, wherein the plurality of instructions further cause the processor to initialize a new instance of the recursive parameter estimator when the measurement is not within a predicted uncertainty region for the event.

26. The one or more non-transitory, computer-readable media of claim 23, wherein the plurality of instructions further cause the processor to terminate an instance of the recursive parameter estimator after a predefined period of time during which no packets including a new measurement of the event are received or overheard by the first node.

27. The one or more non-transitory, computer-readable media of claim 26, wherein the communications schedule of the first node is adapted to a lowest duty cycle in response to the termination of the instance of the recursive parameter estimator.

28. The one or more non-transitory, computer-readable media of claim 17, wherein adapting the communications schedule of the first node comprises adjusting a duty cycle of a radio of the first node.

29. The one or more non-transitory, computer-readable media of claim 28, wherein adjusting the duty cycle of the radio of the first node comprises determining to which probability subspace of a predicted uncertainty region of an event the first node belongs.

30. The one or more non-transitory, computer-readable media of claim 28, wherein adjusting the duty cycle of the radio of the first node comprises exponentially varying a frame length utilized by the radio of the first node.

31. The one or more non-transitory, computer-readable media of claim 17, wherein the plurality of instructions further cause the processor to transmit a packet containing a dedicated field, the dedicated field including a first bit indicating whether the first node is currently sensing an event.

32. The one or more non-transitory, computer-readable media of claim 31, wherein the dedicated field further includes a second bit indicating whether the first node is currently transferring event-related data.

33. A wireless sensor network comprising:
a plurality of nodes, each node including a control circuit and a radio providing access to a communications medium shared between the plurality of nodes, the control circuit of each node being configured to (i) predict whether an event will occur within a sensing field of that node at a future time and (ii) adjust a duty cycle of the radio of that node in response to the prediction.

34. The wireless sensor network of claim 33, wherein each node comprises a camera and the control circuit of each node is configured to predict whether the camera of that node will observe an object of interest at the future time.

35. The wireless sensor network of claim 33, wherein the control circuit of each node is configured to predict whether an event will occur within a sensing field of that node at a future time by estimating a spatio-temporal event probability at that node.

36. The wireless sensor network of claim 35, wherein the control circuit of each node is configured to estimate a spatio-temporal event probability at that node by integrating a position uncertainty of an event over the sensing field of that node.

37. The wireless sensor network of claim 35, wherein the control circuit of each node is configured to estimate a spatio-temporal event probability at that node using a recursive parameter estimator.

38. The wireless sensor network of claim 37, wherein the recursive parameter estimator comprises one of a Kalman filter and a particle filter.

39. The wireless sensor network of claim 37, wherein the control circuit of each node is further configured to receive or overhear a packet from another node of the plurality of nodes via the radio, the packet including a measurement of an event.

40. The wireless sensor network of claim 39, wherein the control circuit of each node is further configured to estimate a new STEP at that node by updating the recursive parameter estimator using the measurement of the event.

41. The wireless sensor network of claim 39, wherein the control circuit of each node is further configured to initialize a new instance of the recursive parameter estimator when the measurement is not within a predicted uncertainty region for the event.

42. The wireless sensor network of claim 39, wherein the control circuit of each node is further configured to terminate an instance of the recursive parameter estimator after a predefined period of time during which no packets including a new measurement of the event are received or overheard by that node.

43. The wireless sensor network of claim 42, wherein the control circuit of each node is further configured to adjust the duty cycle of the radio of that node to a lowest duty cycle in response to the termination of the instance of the recursive parameter estimator.

44. The wireless sensor network of claim 33, wherein the control circuit of each node is configured to adjust a duty cycle of the radio of that node by determining to which probability subspace of a predicted uncertainty region of an event the that node belongs.

45. The wireless sensor network of claim 33, wherein the control circuit of each node is configured to adjust a duty cycle of the radio of that node by exponentially varying a frame length utilized by the radio of that node.

46. The wireless sensor network of claim 33, wherein the control circuit of each node is further configured to transmit a packet containing a dedicated field via the radio, the dedicated field including a first bit indicating whether that node is currently sensing an event.

47. The wireless sensor network of claim 46, wherein the dedicated field further includes a second bit indicating whether that node is currently transferring event-related data.
